(19) United States
(12) Patent Application Publication
(10) Pub. No.: US 2017/0091880 A1
(43) Pub. Date: Mar. 30, 2017

(54) SYSTEM AND METHOD OF ORDERING AND DELIVERING FOOD

(71) Applicant: THE IMMINENT GROUP INC., LAS VEGAS, NV (US)

(72) Inventors: KANNAN KRISHNAN, STRONGSVILLE, OH (US); DANILO JAVIER SALAS, LAS VEGAS, NV (US)

(21) Appl. No.: 14/866,961

(22) Filed: Sep. 27, 2015

(51) Int. Cl. G06Q 50/12; H04L 29/08; G06Q 10/08

(52) U.S. Cl. CPC G06Q 50/12; G06Q 10/087; G06Q 10/083; H04L 67/02; H04L 67/18; H04L 67/12

(57) ABSTRACT

A system and method of ordering and delivering food accessible through web-enabled devices in which employers, employees and food vendors register into the system. The system and method of ordering and delivering food that enables food vendors to publish food menu items or daily specials; employers to identify and approve food vendors based on geographical areas of service, delivery locations or ranking; employees to develop customizable meal plans, to submit customized food orders to food vendors during specific time durations, to rank food vendors or food menu items and to make payments to food vendors. The system and method of ordering and delivering food groups individual food orders based on selected food vendors and delivery locations and transfers the food orders to the selected food vendors, who review the food orders and notify food order status to employees on their web-enabled devices; and facilitates food order delivering process.

### FIELD OF THE INVENTION

The present invention relates to a system and method of ordering and delivering food in which registered employees of registered employers submit food orders during specific time durations from a selection of registered food vendors, which are identified and approved by registered employers; and delivering of food orders by selected registered food vendors to delivery locations within specific time durations.

### BACKGROUND OF THE INVENTION

Lunch hour in many countries during the work week, is anywhere between 11:00 AM to 2:00 PM and generally lasts for less than an hour, with an exception to business lunches. Lately employees prefer a quick lunch for which people go out, order lunch to go so that they can eat at their desk, get packed lunches from home, or go to the workplace cafeteria. Over the years, it has become a common practice for people to eat lunch at the desk so they can complete their work and perhaps leave early.

However, employees who eat out routinely or don't have time to prepare lunches at home are looking for convenience, variety, promptness, quality food and lower costs without driving to a local restaurant and waiting for lunch, or by going to the workplace cafeteria or by waiting in line for a food truck or by ordering from high cost food delivery service. Moreover, employees looking for healthier lunch options, or with specific dietary needs have a need for ordering customized food.

Similarly restaurants or food vendors are looking for increased sales, avoidable lunchtime rush, expanded lunch preparation times, better prediction of demand, feasibility in offering food delivery service, new channels to increase visibility, focus on maintaining quality standards, etc.

Employers want to minimize productivity losses caused by expanded lunch hours. Also, employers face many challenges in management and operation of workplace cafeterias such as maintaining staff for management and operation, complying with nutritional, hygiene and safety standards, employee satisfaction, etc.

Therefore, there is a need in the area of food ordering and delivery services to meet food preferences of employees, offer order management and delivery support to vendors, and overcome workplace cafeteria management and operation challenges of employers.

Following is a list of few inventions related to food ordering:

US Pat. App. Pub. US 2002/0107747 A1 to Dimitra Gerogianni describes a brokering food order transaction system in which the system receives request for food orders from each buyer and generates a list of one or more sellers, with information regarding availability of the food order, pricing and delivery location of the seller. The buyer selects a seller and the system initiates the food order transaction.

The above mentioned invention does not include features such as buyers creating customized meal plans for routine ordering; grouping of food orders based on geographical location of multiple buyers for efficiency or reducing food delivery cost; and time specific ordering and delivery to enable timely delivery of food.

The invention US 2013/151357 to Peter Roy Havas et al discloses a method for enabling group food orders received from an order co-ordinator, in which participants specify the food order, payment source and an alternative or default food item before an order deadline.

The invention does not allow participants or customers, to select a restaurant or food vendor of their choice; nor allows participants or customers to order food independently or on a routinely basis.

The invention US 2013/124355 describes a system and method for group ordering in which users in a group place an order with the same vendor, and after combining all the individual orders and send the group order to the selected vendor.

The invention, however, does not mention anything about submitting food orders within specified timings. It is important to submit or receive orders within specific time durations, in order to enable restaurants or food vendors to facilitate group delivery of food orders and provide an efficient process.

There exist prior art references that disclose food order brokering system and processing group orders. However, those do not disclose an efficient customized food ordering and delivering system. The present invention solves some of the drawbacks or disadvantages associated with existing food ordering and delivering systems or methods, by specifically providing a system for employees to order customized food on a routinely basis.

### BRIEF SUMMARY OF THE INVENTION

The present invention relates to a system and method of ordering and delivering food which involves employees, employers and food vendors registering into the system. The system then facilitates submission of food orders from registered employees of registered employers to registered food vendors for delivery; creating of customizable meal plans by registered employees; grouping of food orders; ranking of food vendors or food menu items; transferring of grouped food orders to registered food vendors, who review the food orders and send notifications to registered employees on their web-enabled devices; and finally, delivery of food orders is initiated upon confirmation.

The “system” here refers to an information system or computer system with multiple computer programs to receive, process and transform data or information for use in the business process. In the most preferred embodiment of the present invention, the system implements a computer program for performing the various steps described herein; and the system is made available to users through a graphical user interface over a web-enabled device.

According to an embodiment of the present invention, the system for ordering and delivering food includes a plurality of databases to store and update corresponding information of registered employers; registered employees and registered food vendors.

Employer information includes name of employer, employer contact details such as email, phone number and address, number of employees, meal hour timings, food delivery procedures and policies, delivery locations, contact details of authorized personnel, a selection of food vendors, and other details. Registered employers also create or modify a selection of registered food vendors by identifying and approving registered food vendors based on geographical areas of service or delivery locations, accessibility, ranking or any other preferences of registered employers; or by submitting requests to registered food vendors to provide delivery service to delivery locations of registered employers; or reviewing requests received from food vendors.

Food vendor information includes name of vendor, vendor contact details such as email, phone number and address, geographical areas of service, delivery locations, food menu items, customization options, daily specials, ranking, feedback and other details. The system enables registered food vendors to search or submit requests to offer delivery service to registered employers.

Employee information such as name of employee, contact details such as phone number and email, customizable meal plan, delivery locations, payment information and details of employer such as name, phone number, email and address and other details.

The system for ordering and delivering of food facilitates communication of food orders from registered employees of registered employers to registered food vendors; grouping of food orders from registered employees; communication of food orders to registered food vendors; communication of food order status from registered food vendors to registered employees on their web-enabled devices; ranking of registered food vendors; and enables registered food vendors to search or submit requests to offer delivery service to delivery locations of registered employers.

According to another embodiment of the present invention, the system offers a customizable meal plan to registered employees, which allows registered employees to create or modify personalized food menu, food preferences, dietary restrictions, order preferences, delivery locations and comments. The said system for ordering and delivering food submits food orders based on a registered employee's customized meal plan; or as one time customized food orders by registered employees. For example, if order preference in a customizable meal plan is automatic, the system for ordering and delivering food submits the food order of the registered employee as per the employee's personalized food menu in the customizable meal plan. If order preference is confirm, the system for ordering and delivering food sends a message in the form of an email or a text message to the registered employee to review and confirm the food order that is selected from the employee's personalized food menu in the customizable meal plan. The system allows employees to view daily specials published by food vendors, select food menu items and submit food orders.

Another embodiment of the present invention relates to a method of ordering and delivering food in which a registered employee or system submits food orders based on a registered employee's customized meal plan; and the system groups individual food orders from registered employees based on selected registered food vendors and delivery location; transfers grouped food orders to the respective registered food vendors, who then review food orders and send notifications to respective registered employees on their web-enabled devices; and the registered food vendors initiate the food order delivery process upon confirmation.

It is understood that the invention may include any combination of the embodiments described and the teachings provided herein can be applied to other systems, not necessarily the system described herein.

### BRIEF DESCRIPTION OF THE DRAWINGS

The summary of the present invention, as well as the detailed description is better understood when read in conjunction with the accompanying drawings that illustrate one or more exemplary embodiments of the present invention.

FIG. 1 illustrates a process flow in a general implementation of the present invention related to an employer registration into the system;

FIG. 2 illustrates a process flow in a general implementation of the present invention related to an employee registration into the system;

FIG. 3 illustrates a process flow in a general implementation of the present invention related to a food vendor registration into the system;

FIG. 4 illustrates a process flow in a general implementation of the present invention related to a method of ordering and delivering food;

FIG. 5 illustrates the functionality of the system in a general implementation of the present invention; and

FIG. 6 illustrates a customizable meal plan of registered employees of the present invention

FIG. 7 illustrates a process flow in a general implementation of the present invention related to payment of food order by an employee to the food vendor de

### REFERENCE NUMBERS USED IN DRAWINGS

The following numbering is used throughout drawing figures and detailed description to illustrate the present invention:

100 A system for ordering and delivering food

200 An employer

250 Registered employer information

300 An employee

350 Registered employee information

400 A food vendor

450 Registered food vendor information

500 Method of food ordering and delivering

600 Meal plan

### DETAILED DESCRIPTION OF THE INVENTION

The present invention relates to a system and method of ordering and delivering food. In the present invention, employers 200, employees 300, and food vendors 400 register into the system for ordering and delivering food 100.

In the present invention, employers 200 are organizations, institutions, companies or any other entities that register into the system for ordering and delivering food 100. Authorized personnel of registered employers 200 access the system for ordering and delivering food 100 using a graphical user interface accessible through web-enabled devices such as desktops, laptops, smart phones, PDAs, tablet PCs, etc. Examples of authorized personnel are staff members from human resources, procurement or any other department who typically manage operation of cafeteria. In this embodiment, authorized personnel act as representatives of registered employers 200 to access the system for ordering and delivering food 100.

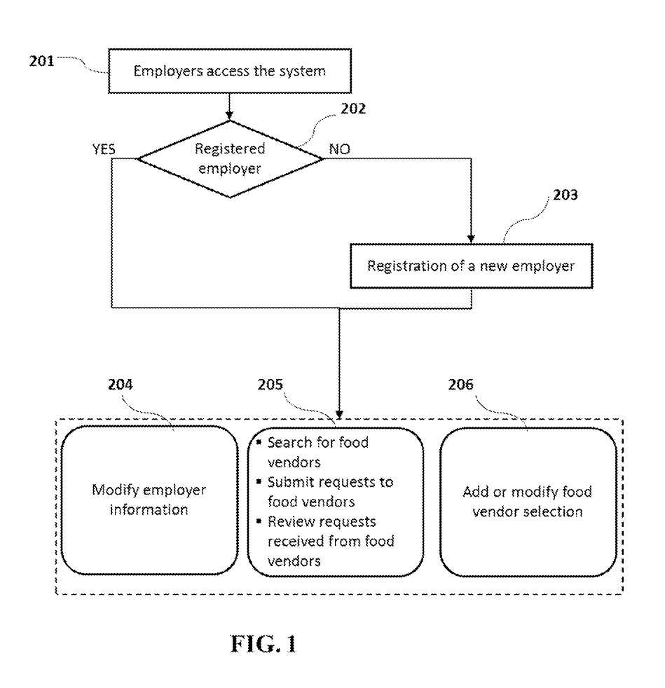

FIG. 1 illustrates a process flow related to an employer 200 registration into the system for ordering and delivering food 100. In step 201, employers 200 access the system for ordering and delivering food 100 using a graphical user interface. In step 202, the system for ordering and delivering food 100 will determine if the employer 200 is already registered into the system. If the employer 200 is not registered into the system for ordering and delivering food 100, then the system guides the employer 200 to register into the system as in step 203. In step 203 a registered employer 200 registers employer information 250 such as name of employer, contact details such as email, phone number and address, number of employees, meal hour timings, food delivery procedures and policies, delivery locations, contact details of authorized personnel, a selection of food vendors, and other details. In step 204, the system for ordering and delivering food 100 allows authorized personnel of registered employers 200 to modify or delete registered employer information 250.

In step 205, authorized personnel of registered employers 200 access the system for ordering and delivering food 100 to search for registered food vendors 400 based on their geographical areas of service, delivery locations, food vendors name and geographical locations of employers 200; or review requests received from registered food vendors 400; or submit requests to registered food vendors 400 to offer delivery service to delivery locations of registered employers 200. In step 206, authorized personnel of employers 200 identify and approve a selection of registered food vendors based on geographical locations, delivery locations, accessibility, ranking, feedback and any other preferences of registered employers 200; and a selection of registered food vendors becomes available to registered employees.

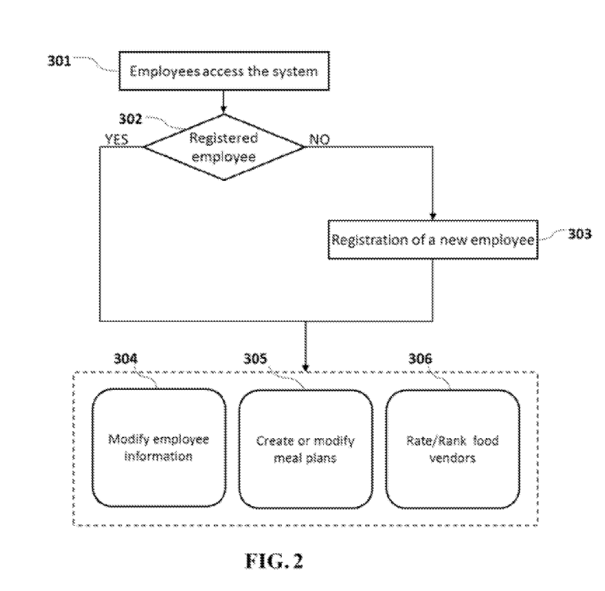

FIG. 2 illustrates a process flow related to an employee 200 registration into the system for ordering and delivering food 100. In the step 301, employees 300 of a registered employer 200 access the system for ordering and delivery food 100 using a graphical user interface. In step 302, the system for ordering and registering food 100 will determine if the employee 300 is already registered into the system. If the employee 300 is not registered into the system for ordering and delivering food 100, then the system guides the employee 300 to register into the system as in step 303. In step 303, a registered employee 300 registers employee information 350 such as name of employee, contact details such as phone number and email, customizable meal plan, delivery locations, payment information and details of employer such as name, phone number, email and address and other details. In step 304, registered employees 300 can modify employee information 350. In step 305, employees 300 create or modify customized meal plans 600. In step 306, employees 300 rate or rank the food vendors or food menu items, or provide feedback on registered food vendors 400.

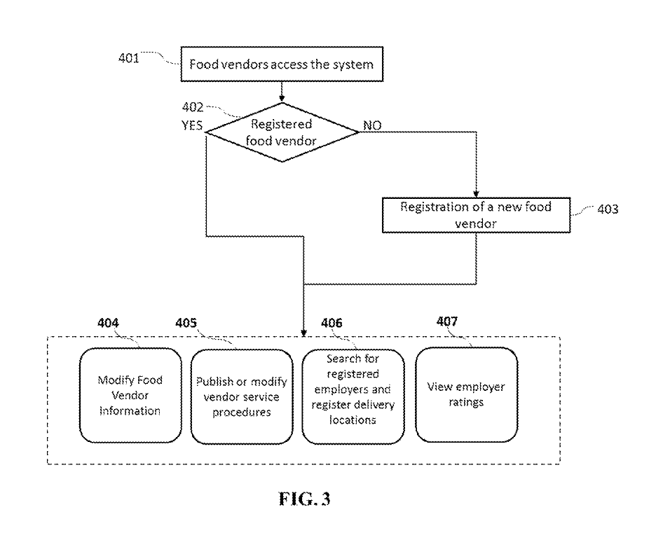

FIG. 3 illustrates a process flow related to a food vendor 400 registration into the system for ordering and delivering food 100. In step 401, food vendors 400 access the system for ordering and delivering food 100 using a graphical user interface. In step 402, the system for ordering and delivering food will determine if the food vendor 400 is already registered. In step 403, if the food vendor 400 is not registered into the system for ordering and delivering food 100, then the system guides the food vendors 400 to register into the system. In step 403, a food vendor 400 registers vendor information 450 such as name of vendor, contact details such as email, phone number and address, geographical areas of service, delivery locations, food menu items, customization options, daily specials and other details. In step 404, registered food vendors 400 modify registered food vendor information 450. In step 405, registered food vendors 400 publish or modify vendor service procedures such as food menu items, customization options, daily specials, meal hour timings or durations to receive food orders. In step 406, registered food vendors search for registered employers 200 and register delivery locations; or review requests received from registered employers 200. In step 407, registered food vendors 400 view the ratings or feedback submitted by registered employees 300 or registered employers 200.

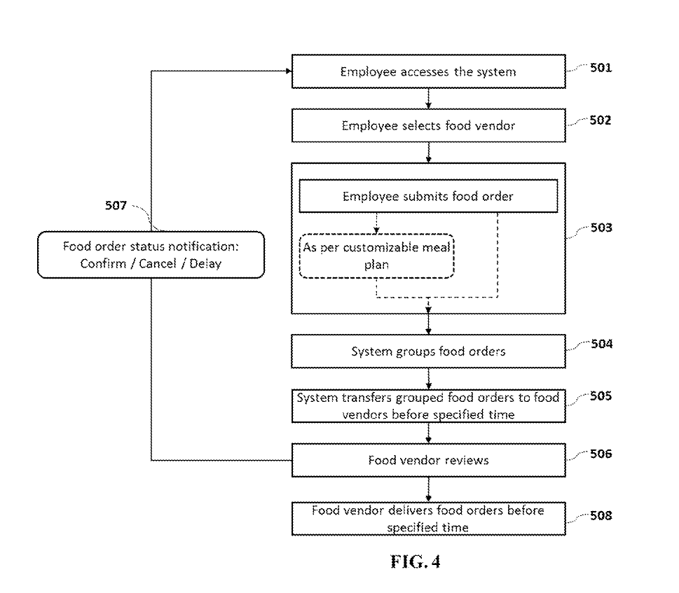

FIG. 4 illustrates a method of ordering and delivering food. In step 501, an employee 300 accesses the system 100 using a graphical user interface. In step 502, a registered employee 300 selects a registered food vendor 400 from a selection of registered food vendors identified and approved by registered employers 200 and submits a food order before or within meal hour timings specified by a registered employer 200.

In step 503, a registered employee 300 submits food order based on the food menu items or daily specials published by registered vendor 400, or the system 100 automatically submits food order as per order preferences 604 in the customizable meal plan 600. For example, if order preference in a customizable meal plan is automatic, the system for ordering and delivering food submits the food order of the registered employee as per the employee's personalized food menu in the customizable meal plan. If order preference is confirm, the system for ordering and delivering food sends a message in the form of an email or a text message to the registered employee to review and confirm the food order that is selected from the employee's personalized food menu in the customizable meal plan. The system allows employees to view daily specials published by food vendors, select food menu items and submit food orders.

In step 504, the system for ordering and delivering food 100, groups all food orders submitted by registered employees 300. The system 100 groups submitted food orders by registered food vendors 400 and by delivery locations. In step 505, the system transfers grouped food orders to registered food vendors 400 before meal hour timings or durations to receive order as specified by registered food vendors 400. In step 506, registered food vendors 400 review food orders received from the system 100. In step 507, registered food vendors 400 send a notification message to registered employees on their web-enabled devices 300 regarding confirmation, cancellation, delay or any other message related to the food order. In step 508, registered food vendor 400 delivers the food order as per registered employers 200 food delivery procedure and policies, unless the food order gets cancelled.

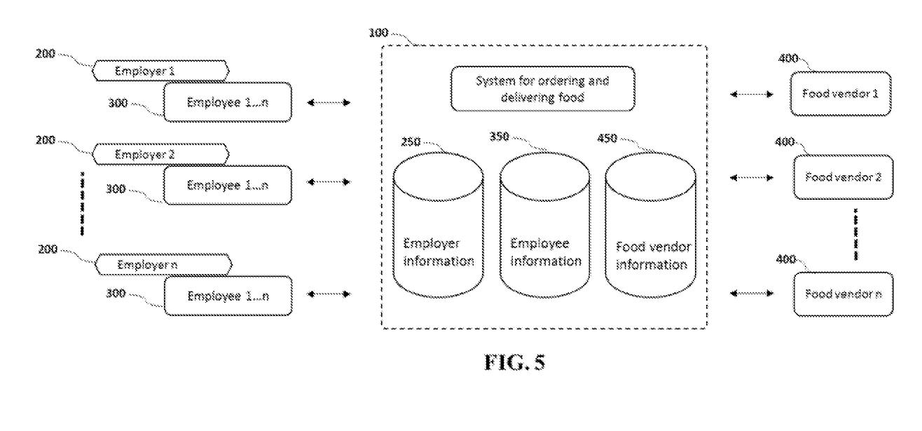

FIG. 5 illustrates a system for ordering and delivering food 100. Employers 200, employees 300 and food vendors 400 register into the system for ordering and delivering food 100. The system for ordering and delivering food 100 comprises of multiple databases to store and update employer information 250, employee information 350 and food vendor information 450.

The system for ordering and delivering food 100 comprises of a database to store registered employer information 250 employer name, employer contact details such as email, phone and address, number of employees, meal hour timings, food delivery procedures and policies, delivery locations, contact details of authorized personnel, a selection of registered food vendors, and other details.

The system for ordering and delivering food 100 comprises of a database to store and update registered employee information 350 such as employee name, employee contact details such as phone and email, their employer details such as name, phone, email and address, payment information, delivery locations and other details.

The system for ordering and delivering food 100 comprises of a database to store and update registered food vendor information 450 such as vendor name, vendor contact details such as email, phone and address, geographical areas of service, delivery locations, food menu items, customization options, daily specials, ranking, feedback and other details.

The system for ordering and delivering food 100 facilitates ordering and delivering of food by communication of food orders from registered employees 300 to registered food vendors 400; grouping of food orders from registered employees 300; ranking of registered food vendors 400; communication of food orders to registered food vendors 400; and communication of food order status from registered food vendors 400 to registered employees 300 on their web-enabled devices.

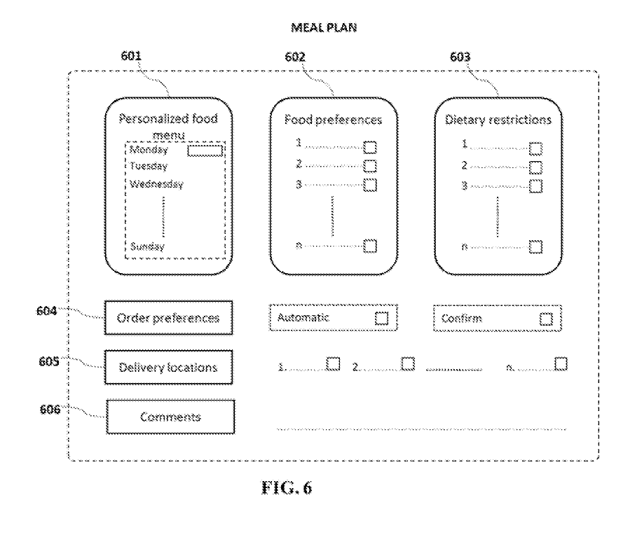

FIG. 6 illustrates a meal plan 600 of a registered employee 300. A meal plan 600 allows a registered employee 300 to create or modify personalized food menu 601; create or modify food preferences 602; create or modify dietary restrictions 603; create or modify order preferences 604; add or modify delivery locations 605; and include any other comments 606. A registered employee 300 reviews food menu items published by registered vendors 400 and creates or modifies a daily or weekly personalized food menu 601 which includes choices of food dishes from one or more registered food vendors 400 which are available from selection of food vendors 400 facilitated by registered employers 200. A registered employee 300 creates or modifies food preferences 602 to include or exclude food ingredients or side dishes. A registered employee 300 creates or modifies dietary restrictions 603 to specify food restrictions or preferences as per dietary needs of registered employee 300. A registered employee 300 creates or modifies order preferences 604. Order preferences 604 are settings that indicate means of automatic submission or requirement to confirm submission of food orders. If order preferences 604 are set for automatic submission, the system 100 will submit food order of registered employee as per personalized food menu 601. If order preferences are set for confirm, the system 100 will allow registered employee 300 to review and confirm a food order which is selected from personalized food menu 601, using a single step or single click method based on a message received to registered employee 300 in the form of an email, or a text message, or a reminder on a web-enabled device. A registered employee 300 will add or modify delivery locations 605 by either registering or selecting from one or more delivery locations 605 of a registered employer 200. A registered employee 300 can mention any other details as per their preferences in the comments 606 of a meal plan 600.

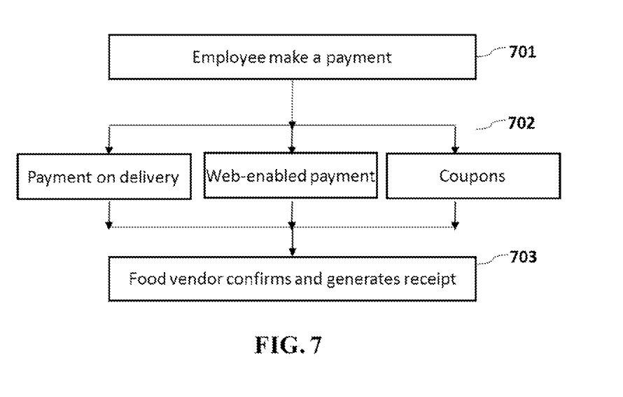

FIG. 7 illustrates payment method of food order by registered employee 300 to the registered food vendor 400. In step 701, a registered employee 300 makes a payment to a registered food vendor 400. In step 702, the registered employee 300 has multiple payment options available such as payment on delivery, web-enabled payment and discounted payments using coupons or alike. The registered employee 300 selects one of the payment options. In the case, of payment using coupons is selected, the system manages the discounting process of payments. The registered food vendor 400 receives payment for registered employee 300 and submits receipt to the registered employee.

We claim:

1. A system for ordering and delivering food comprising of:
a feature that enables communication among employees, employers and food vendors;
a feature that enables employees, employers and food vendors to store and update respective information;
a feature that enables employers to identify and approve food vendors;
a feature that enables employees to develop customizable meal plans;
a feature that enables employees to submit customized food orders;
a feature that enables employees to rank food vendors or food menu items;
a feature that enables employees to make payments to food vendors;
a feature to group orders; and
a feature that enables food vendors to review food orders, notify food order status and deliver food orders at delivery locations and within specified timings

2. The system for ordering and delivering food of claim 1, wherein communication among employees, employers and food vendors is by using a graphical user interface accessible through web-enabled devices.

3. The system for ordering and delivering food of claim 1, wherein employees can store and update their information including name of employee, contact details such as phone number and email, customizable meal plan, delivery locations, payment information and details of employer such as name, phone number, email and address.

4. The system for ordering and delivering food of claim 1, wherein employers can store and update their information including name of employer, contact details such as email, phone number and address, number of employees, meal hour timings, food delivery procedures and policies, delivery locations, contact details of authorized personnel and a selection of food vendors.

5. The system for ordering and delivering food of claim 1, wherein food vendors can store and update their information including name of vendor, contact details such as email, phone number and address, geographical areas of service, delivery locations, food menu items, customization options, daily specials and ranking.

6. The system for ordering and delivering food of claim 1, wherein employers can identify and approve a selection of food vendors by
searching for food vendors using criteria such as geographical areas of service or delivery locations,
submitting requests to food vendors in the system; or
reviewing requests received from food vendors.

7. The system for ordering and delivering food of claim 1, wherein employees can develop customizable meal plans comprising of personalized food menu, food preferences, dietary restrictions, order preferences, delivery locations and comments.

8. The system for ordering and delivering food of claim 7, wherein said personalized food menu can be created or modified by reviewing the food menu items, daily specials and utilizing customization options published by food vendors.

9. The system for ordering and delivering food of claim 7, wherein said food preferences include or exclude food ingredients or side dishes.

10. The system for ordering and delivering food of claim 7, wherein said dietary restrictions specify food restrictions or preferences as per dietary needs of employees.

11. The system for ordering and delivering food of claim 7, wherein said order preferences are settings for submitting food orders by means of an automatic submission or requirements for confirmation of submission.

12. The system for ordering and delivering food of claim 11, wherein
if said order preferences are set for automatic submission, the system will submit food orders of registered employees as per personalized food menu;
and if said order preferences are set for confirm, the system will allow employees to review and confirm food orders, that are selected from personalized food menu, using a single step or single click method based on a message received to employees in the form of an email, or a text message, or a reminder on a web-enabled device.

13. The system for ordering and delivering food of claim 7, wherein said delivery locations are registered by employees or selected by employees from one or more delivery locations of employers.

14. The system for ordering and delivering food of claim 7, wherein said comments allow employees to mention any other details as per their preferences.

15. The system for ordering and delivering food of claim 1, wherein employees can submit customized food orders by reviewing daily specials or food menu items published by food vendors and selecting food vendors from the system; or
as per the customizable meal plan.

16. The system for ordering and delivering food of claim 1, wherein
employees have multiple options to make payments to food vendors comprising of web-enabled payment, payment on delivery of food order, or discounted payment using coupons or alike.

17. The system for ordering and delivering food of claim 1, wherein
food vendors review food orders;
notify food order status to said employees on web-enabled devices;
and deliver food orders to said delivery locations within said specified timings that are within meal hour timings stated by employers.

18. A method for ordering and delivering food comprising the steps of:
employers, employees and food vendors registering into the system;
employers identifying and approving food vendors;
employees submitting customized food orders;
employees making payments to food vendors;
grouping and transferring submitted food orders;
food vendors reviewing food orders, notifying food order status and delivering food orders.

19. The method of ordering and delivering food as in claim 18, wherein employers identifying and approving food vendors further comprises the step of
searching for food vendors based on their geographical areas of service, delivery locations, accessibility or ranking; or
submitting requests to food vendors in the system to offer delivery service to delivery locations of employers; or
reviewing requests received from food vendors.

20. The method of ordering and delivering food as in claim 18, wherein employees submitting customized food orders further comprises the step of
employees reviewing daily specials or food menu items published by food vendors and
submitting customized food orders by selecting food vendors from the system; or
as per the customizable meal plan of the employees.

21. The method of ordering and delivering food of claim 18, wherein
employees have select one of the multiple options to make payments to food vendors comprising of web-enabled payment, payment on delivery of food order, or discounted payment using coupons or alike; processing respective payment methods to the food vendors; and providing payment receipts to employees.

22. The method of ordering and delivering food as in claim 18, wherein grouping of the submitted food orders is further implemented by grouping food orders based on food vendors and delivery locations; and
transferring grouped food orders to food vendors.

23. The method of ordering and delivering food as in claim 18, wherein food vendors reviewing and delivering food orders is further implemented by food vendors reviewing food orders; notifying food order status to the employees on web-enabled devices; and initiating food delivery process.
